(19) United States
(12) Patent Application Publication
(10) Pub. No.: US 2025/0204680 A1
(43) Pub. Date: Jun. 26, 2025

(54) Stackable Furniture Assembly

(71) Applicants: ACT ENGINEERING SDN. BHD., BATU PAHAT (MY); NEXUS BERSATU SDN. BHD., MUAR (MY)

(72) Inventor: Yi Hua LEE, MUAR (MY)

(21) Appl. No.: 18/988,219

(22) Filed: Dec. 19, 2024

(30) Foreign Application Priority Data
Dec. 20, 2023 (MY) PI2023007791

(51) Int. Cl. A47B 87/02

(52) U.S. Cl. CPC A47B 87/0284

(57) ABSTRACT

A furniture assembly includes a plurality of segmental portions configured to be stackable one on top of another to form a complete furniture body. Each segmental portion includes at least one drawer, at least one interlocking mechanism, and at least one securing member for stabilizing the segmental portions and preventing unintended disassembly. The interlocking mechanism includes a locking bar slidably disposed on a side panel of the segmental portion, having a plurality of spaced protrusions distributed along a length of the locking bar, and a rotatable block having a first portion pivotably connected to the side panel of the segmental portion, a second portion engageable by a sliding mechanism of a respective drawer, and a third portion that is engageable with one of the protrusions. The locking bars of two adjacent segmental portions are connected by a detachable connector.

### CROSS-REFERENCE TO RELATED APPLICATIONS

This application claims priority to, and the benefit of, Malaysian Patent Application No. PI2023007791, filed Dec. 20, 2023. The contents of that application are incorporated by reference in their entirety.

### TECHNICAL FIELD

The invention relates to a furniture assembly. More particularly, the invention relates to a stackable furniture assembly with improved interlocking mechanism.

### BACKGROUND

A cabinet with drawers is commonly used in places such as households and workplaces to store articles in an organized manner. Conventionally, the drawers of the cabinet can be freely opened and closed in a selective manner. The convenience of accessing items with ease and maintaining a clutter-free environment has contributed to their widespread popularity. Nevertheless, such cabinets have critical safety concerns, particularly in households with young children. The potential hazard they pose is that when curious kids attempt to open drawers and inadvertently use them as a means to climb. This behaviour poses a serious safety risk as it can lead to the cabinet tipping over, causing harm or injury to the child.

Over the years, safety locking mechanism has been incorporated into the cabinet with drawers to address the aforementioned issue. For instance, China Patent No. CN106837009A discloses a multi-drawer locking device for a cabinet with multi-layer drawers. The multi-drawer locking device generally comprises a guide groove, a first slider, a plurality of second slider, and a wedge-shaped block disposed at front end of an inner rail of each drawer. Each of the second slider comprises a limiting block and a roller. When one of the drawer is opened by pulling outwards, the roller corresponding to the opened drawer moves along the wedge-shaped block and the inner rail of the drawer, which drives the second sliders of the remaining drawers above the opened drawer to move upwardly. Consequently, the position of the limiting blocks of the remaining drawers above the opened drawer blocks the wedge-shaped blocks of the remaining drawers from outward movement, thereby preventing the remaining drawers above the opened drawer from being pulled outwardly. On the other hand, the movement of the second sliders of the remaining drawers below the opened drawer is blocked by the limiting block and the inner rail of the drawer, thereby preventing the remaining drawers below the opened drawers from being pulled outwardly.

The existing cabinet drawer locking devices have proven effective for conventional furniture. Nonetheless, they face limitations when applied to customizable and stackable cabinets. The inherent challenge lies in their fixed-dimension mechanisms, which are not adaptable to the variable configuration of stackable cabinets. Accordingly, it would be desirable to provide a furniture assembly that can address the challenges as described above. This invention provides such a stackable furniture assembly and its interlocking mechanisms.

### BRIEF SUMMARY

In one aspect of the invention, there is provided a furniture assembly comprises a plurality of segmental portions configured to be stackable one on top of another to form a complete furniture body; wherein each segmental portion includes at least one drawer, at least one interlocking mechanism, and at least one securing member for stabilizing the segments and prevent unintended disassembly; wherein the interlocking mechanism includes a locking bar slidably disposed on an inner side of the side panel of the segmental portion, having a plurality of spaced protrusion distributed along a length of the locking bar, and a rotatable block having a first portion pivotably connected to the inner side of the side panel of the segmental portion, a second portion engageable by a sliding mechanism of a respective drawer, and a third portion that is engageable with one of the protrusions; wherein the locking bars of two adjacent segmental portions are connected by a detachable connector such that all the locking bars of the stacked segmental portions are interconnected with synchronized movements and the interconnected locking bars are movable between a locked position and an unlocked position; and wherein when one of the drawers is moving towards the open position, at least one sliding mechanism of that particular drawer engages the second portion of the corresponding rotatable block, and concurrently, the third portion of that corresponding rotatable block moves to engage with the respective protrusion, thereby moving the interconnected locking bars to the locked position, causing the remaining protrusions on the interconnected locking bars to move in a synchronized manner to a position that intercept a rotation pathway of the remaining rotatable blocks, preventing the remaining drawers from movement.

Preferably, the rotatable blocks may be a T-shaped blocks.

Preferably, the connector may include a plurality of holes for receiving the protrusions on the locking bars, each hole includes a larger protrusion receiving portion to easily accommodate the protrusion and a narrowed protrusion receiving portion to allow the received protrusion to slide thereinto for firm gripping of the protrusion.

Preferably, at least one end of each locking bar may include at least one dovetail tongue profile that is insertable to a dovetail tongue receiving portion of the connector to form a dovetail joint.

Preferably, at least one end of each locking bar may include a protrusion that is insertable into a recess on the connector and an opening dimension of the recess is slightly narrower than the diameter of the protrusion in such a way that it can be inserted into the recess in a snap-on manner.

Preferably, at least one end of each locking bar may include an enlarged head portion that is insertable into a recess on the connector and is secured by a pair of snap-fit members, forming a cantilever snap-fit joint.

Preferably, the securing member may comprise a body having a plurality of pins for insertion to corresponding pinholes on the inner side of the side panel, and a tongue profile on one edge of the body.

Preferably, the securing member may be attached to the inner side of the side panel at a position between two adjacent segmental portions in a first orientation where at least one of the pins is inserted to the pinhole of one segmental portion and the other pin is inserted to the pin hole of the other segmental portion, thereby securing the stacking connection between the adjacent segmental portions.

Preferably, the securing member may be attached to the inner side of the side panel of a respective segmental portion in a second orientation where the tongue profile is readily positioned to be inserted to a groove of a further panel, thereby connecting the further panel to the respective segmental portion via a tongue and groove interlocking joint.

Preferably, the securing member may include a second portion with a plurality of serrated teeth for insertion into prefabricated holes on a first segmental portions, and a first portion with an enlarged end portion for either the attachment of a further panel or the insertion into a prefabricated hole on a second segmental portion to align the first and second segmental portions during stacking.

Preferably, the stacked segmental portions may be further secured by an attachment of at least one further panel.

Preferably, the segmental portions may be stacked and joined via dowel pins.

Preferably, each segmental portion may include a flange portion that extends towards an adjacent segmental portion, the flange portion serves as a guide to facilitate the stacking of the segmental portions.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1A-1E illustrates a process of assembling a furniture assembly in its first embodiment.

FIG. 2 is a perspective diagram illustrating a second embodiment of the furniture assembly.

FIG. 3 is a perspective diagram illustrating a third embodiment of the furniture assembly.

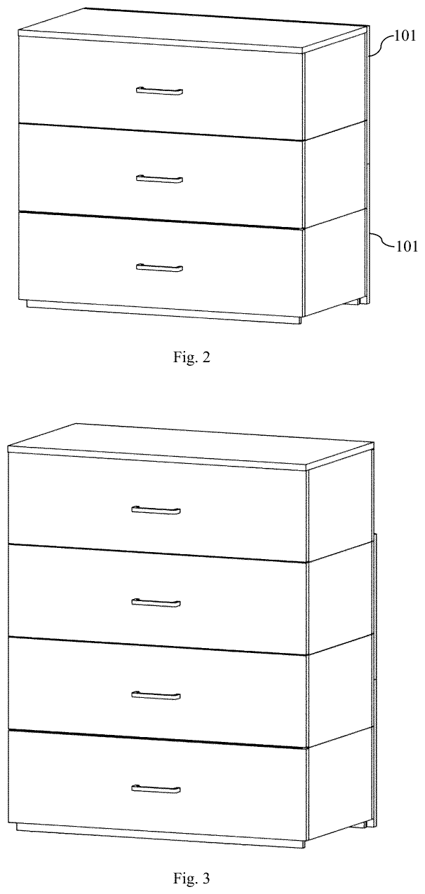

FIG. 4 is a side view diagram of the furniture assembly illustrating an interlocking mechanism.

FIGS. 5A & 5B illustrates a first embodiment of a locking bar and a connector of the interlocking mechanism.

FIGS. 6A & 6B illustrates a second embodiment of the locking bar and the connector.

FIGS. 7A & 7B illustrates a third embodiment of the locking bar and the connector.

FIGS. 8A & 8B illustrates a fourth embodiment of the locking bar and the connector.

FIGS. 9A-9D illustrates a securing member of the furniture assembly.

FIGS. 10A & 10B illustrates an attachment of the securing member to the stacked assembly in its first orientation.

FIGS. 11A-11C illustrates the attachment of the securing member to the stacked assembly in its second orientation.

FIGS. 12A & 12B illustrates a further embodiment of the securing member of the furniture assembly during the attachment of a top panel.

FIG. 13 illustrates the further embodiment of the securing member during stacking of the segmental portions.

### DETAILED DESCRIPTION

The invention generally provides a furniture assembly having a plurality of segmental portions configured to be stackable one on top of another to form a complete furniture body. Preferably, each segmental portion includes at least one drawer that is operable, via its respective sliding mechanisms, between an open configuration and a closed configuration. In order to improve the safety and stability of the stacked furniture assembly, interlocking mechanisms and securing members are provided. To preserve the inherent stackability and detachability of the assembly, two adjacent components of the interlocking mechanisms are interconnected through a detachable connector. Furthermore, the securing members are operatable in at least two orientations, thereby providing a greater customization options for the furniture assembly.

The invention will now be described in greater detail, by way of example, with reference to the drawings.

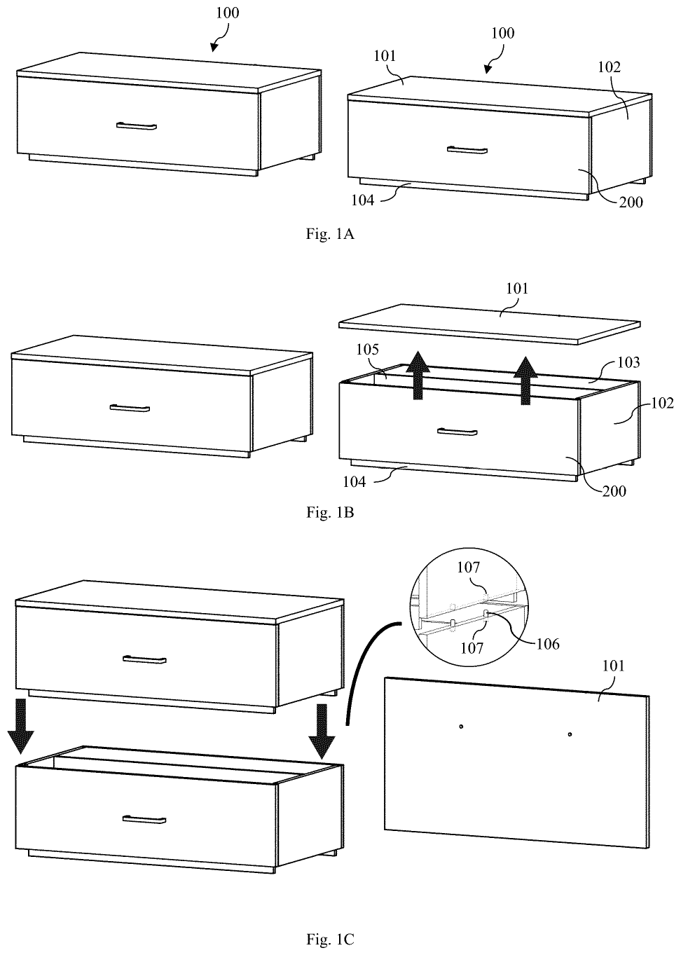

Referring to FIGS. 1A-1E, the process of assembling the furniture assembly in its first embodiment is illustrated. Preferably, the furniture assembly comprises a pair of identical segmental portions 100 that are stackable one on top of another to form a complete furniture body. Each segmental portion 100 includes a compartment formed by a pair of side panels 102, a rear panel 103, a top detachable panel 101, first supporting panels 104, and a second supporting panel 105. The compartment can be initially provided with a front opening for receiving a drawer 200 and a bottom opening. The drawer 200 can be coupled to its respective segmental portion 100 via a sliding mechanism. The sliding mechanism can be a pair of roller slide assemblies. Each roller slide assembly can include a drawer sliding guide 210 that is attached to the side panel 102, and a drawer runner 211 that is attached to the drawer 200. The drawer runner 211 may comprise rollers or ball bearings that glide along the drawer sliding guide 210, allowing the drawer 200 to move between an open position and a closed position smoothly.

To stack the two segmental portions 100, the top detachable panel 101 of the first segmental portion 100 is firstly removed to create a top opening for the second segmental portion 100 to be placed thereon. By way of example, the first supporting panels 104 of the second segmental portion 100 can be extended outwardly, forming a flange portion that can be inserted into the top opening of the first segmental portion 100. The flange portion serves as a guide to facilitate the stacking of the segmental portions 100. The side panels 102 of both the segmental portions 100 are provided with a plurality of pinholes 107 that are aligned and connected through pins 106, creating a dowel attachment. Nevertheless, it should be understood that the dowel attachment can be easily replaced by other types of commercially available attachment joints. Not only can the attachment be on the side panels 102 of the segmental portions 100, but it can also be on the rear panel 103 or even the first supporting panels 104. After placing the two segmental portions 100 on top of each other, the earlier removed top panel 101 can then be attached to the rear panels 103 of both segmental portions 100. This effectively transforms the top panel 101 into a counterweight, which helps to prevent the furniture assembly from tipping over. The attachment of the top panel 101 also secures the stacked assembly from unintended disassembly.

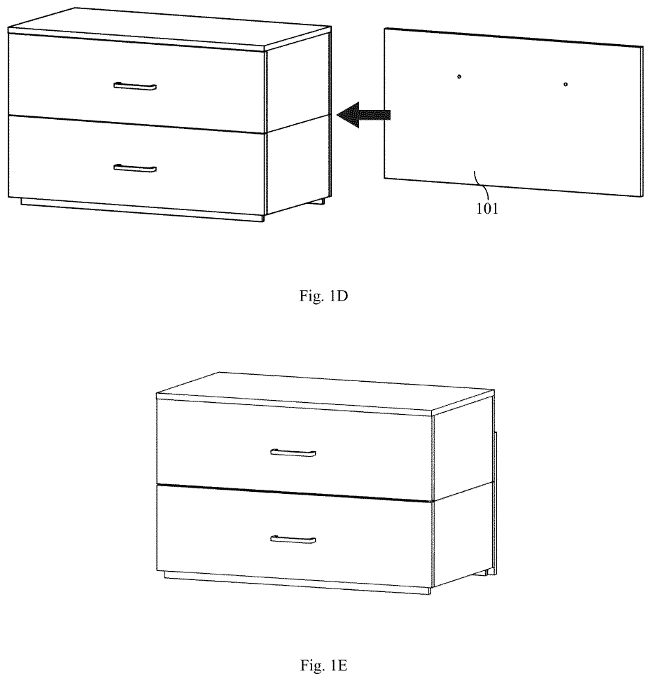

FIGS. 2 & 3 illustrates that the furniture assembly can have three or more segmental portions 100 stacked on top of another to form a cabinet with three or more drawers. In this embodiment, the extra top panels 101, which are removed during the stacking process, can be all attached in a side by side manner to the rear panels 103 of the stacked assembly for stabilizing the segmental portions 100 and acting as a counterweight.

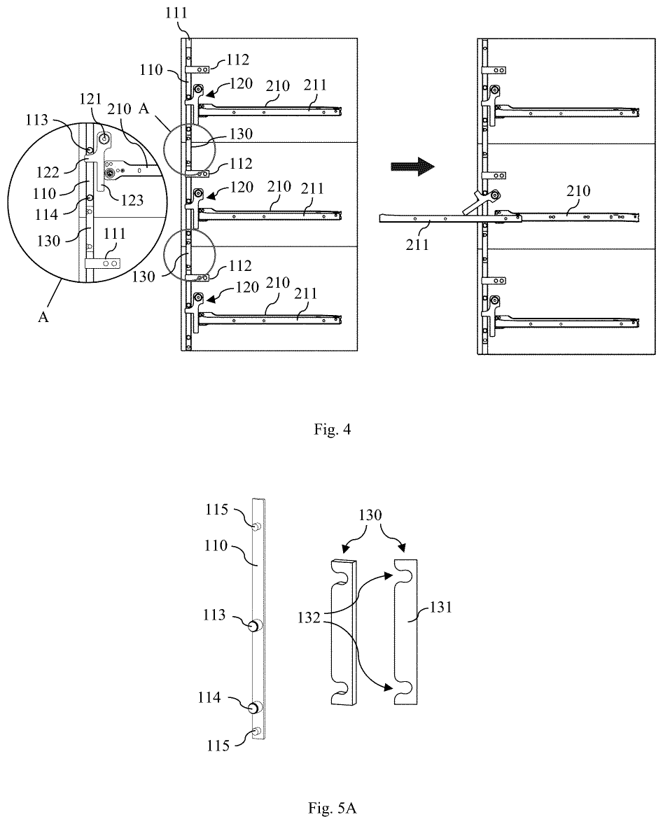

Referring to FIG. 4, the furniture assembly is incorporated with an interlocking mechanism in each segmental portion 100 to serve as an anti-tipping mechanism. Individually, these interlocking mechanisms do not serve any purpose. However, when the interlocking mechanisms of the stacked segmental portions are connected, they enable only one drawer 200 to open while keeping the rest of the drawers locked in their closed position.

Preferably, each interlocking mechanism includes a locking bar 110 and a rotatable block 120. The locking bar 110 is placed on the inner side of the side panel 102 of the segmental portion 100 in a sliding manner. The inner side of the side panel 102 of the segmental portion 100 can have a groove 111 to accommodate the locking bar 110. The locking bar 100 can be secured within the groove 111 using an attachment component 112. The locking bar 100 includes a plurality of spaced protrusions 113, 114 that are distributed along its length and the locking bar 110 is slidable between a locked position and an unlocked position within the groove 111. The locking bars 110 of two adjacent segmental portions 100 are connected by a detachable connector 130 such that all the locking bars 110 of the stacked segmental portions 100 are interconnected with synchronized movements.

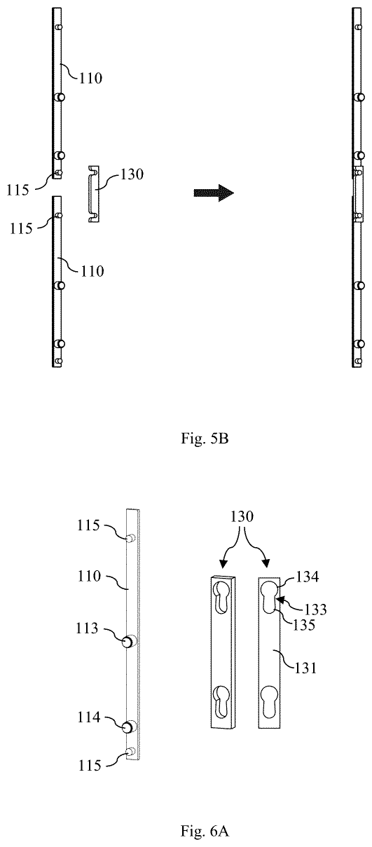

Referring to FIG. 5A, a first example of the locking bar 110 and the connector 130 is illustrated. In this embodiment, the connector 130 includes an elongate body 131 and two recesses 132 formed at the end portions of the elongate body 131. Each recess 132 is configured to accommodate a further protrusion 115 of the locking bar 110. In one specific embodiment, the dimension of the opening of each recess 132 is slightly narrower than the diameter of the further protrusion 115 so that when the connector 130 connects the locking bars 110 from two adjacent segmental portions 100, it creates a snap-on effect as shown in FIG. 5B.

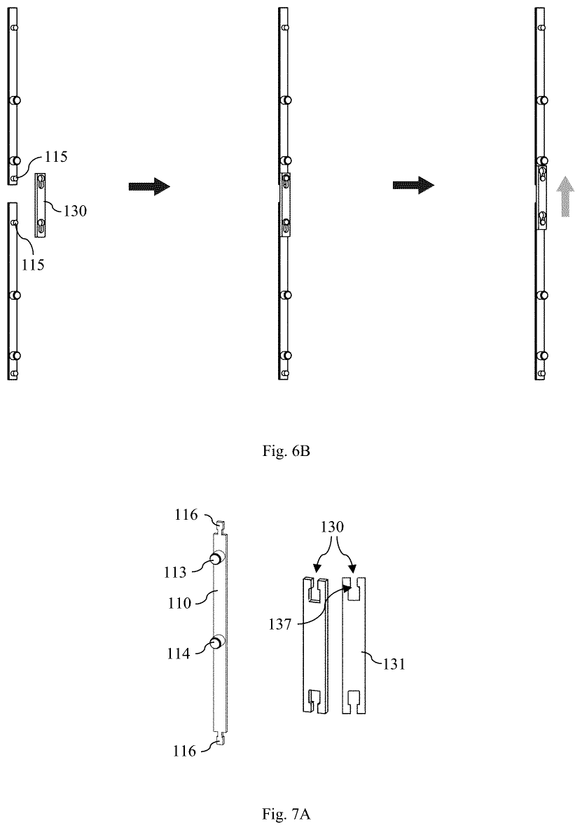

Referring to FIG. 6A, a second example of the locking bar 110 and the connector 130 is illustrated. In this embodiment, the connector 130 includes the elongate body 131 and two holes 133 at the end portion of the elongated body 131. Each hole 133 includes a larger protrusion receiving portion 134 to easily accommodate the further protrusion 115 of the locking bar 110 and a narrowed protrusion receiving portion 135 to allow the further protrusion 115 to slide thereinto for firm gripping as shown in FIG. 6B.

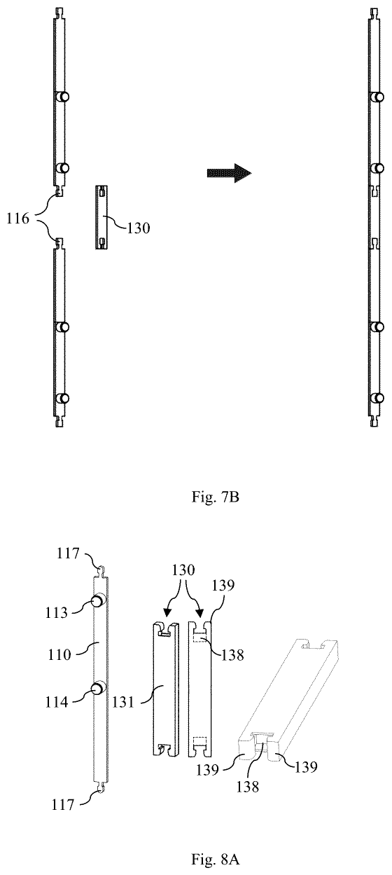

Referring to FIG. 7A, a third example of the locking bar 110 and the connector 130 is illustrated. In this embodiment, the connector 130 includes the elongate body 131 and a dovetail tongue receiving portion 137 on each end of the elongate body 131. The dovetail tongue receiving portions 137 are each configured to receive a dovetail tongue profile 116 of the locking bar 110 as shown in FIG. 7B.

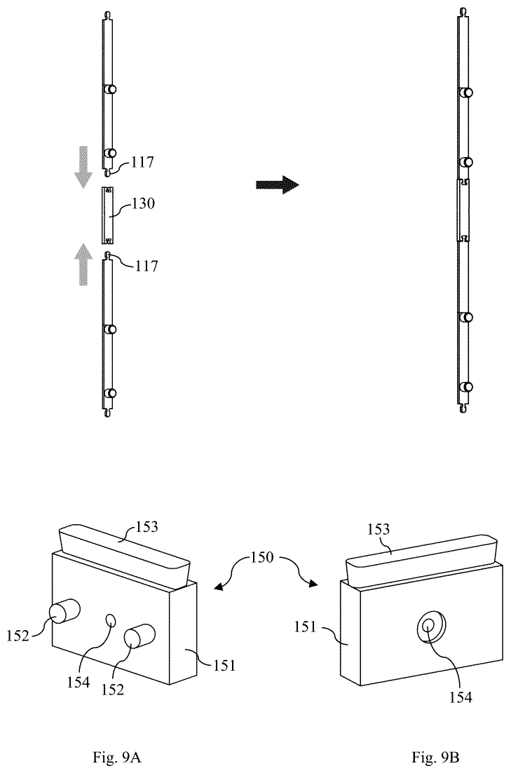

Referring to FIG. 8A, a fourth example of the locking bar 110 and the connector 130 is illustrated. In this embodiment, the connector 130 includes the elongate body 131, a recess 138 on each end of the elongate body 131, and a pair of snap-fit members 139 at an opening of each recess 138. The recesses 138 are each configured to accommodate an enlarged head portion 117 of the locking bar 110, and the pair of snap-fit members 139 secures the enlarged head portion 117 within the recess 138, thereby forming a cantilever snap-fit joint as shown in FIG. 8B.

Preferably, each rotatable block 120 comprises a first portion 121 that is pivotably connected to the inner side of the side panel 102, a second portion 123 that is engageable by the sliding mechanism of a respective drawer 200, and a third portion 122 that is engageable with one of the protrusions 113, 114. In one specific embodiment, the rotatable blocks 120 are T-shaped blocks with their first portion 121 at an upper section pivoted to the inner side of the side panel 102, their second portion 123 at the lower section intercepting the pathway of the sliding mechanism, and their third portion 122 at a middle section that extends sideways to reach the protrusion 113 of the locking bar 110.

Referring back to FIG. 4, when one of the drawers 200 is moving towards the open position, the sliding mechanism of that particular drawer 200 engages the second portion 123 of the corresponding rotatable block 120, and concurrently, the third portion 122 of that corresponding rotatable block 120 moves to engage with the respective protrusion 113, thereby moving the interconnected locking bars 110 to the locked position, causing the remaining protrusions 114 on the interconnected locking bars 110 to move in a synchronized manner to a position that intercept a rotation pathway of the remaining rotatable blocks 120, preventing the remaining drawers 200 from movement. In one specific embodiment, the remaining protrusions 114 obstruct the pathway of the second portion 123 of the remaining rotatable blocks 120, thereby obstructing the moving pathway of the sliding mechanisms of the remaining drawers 200 as well.

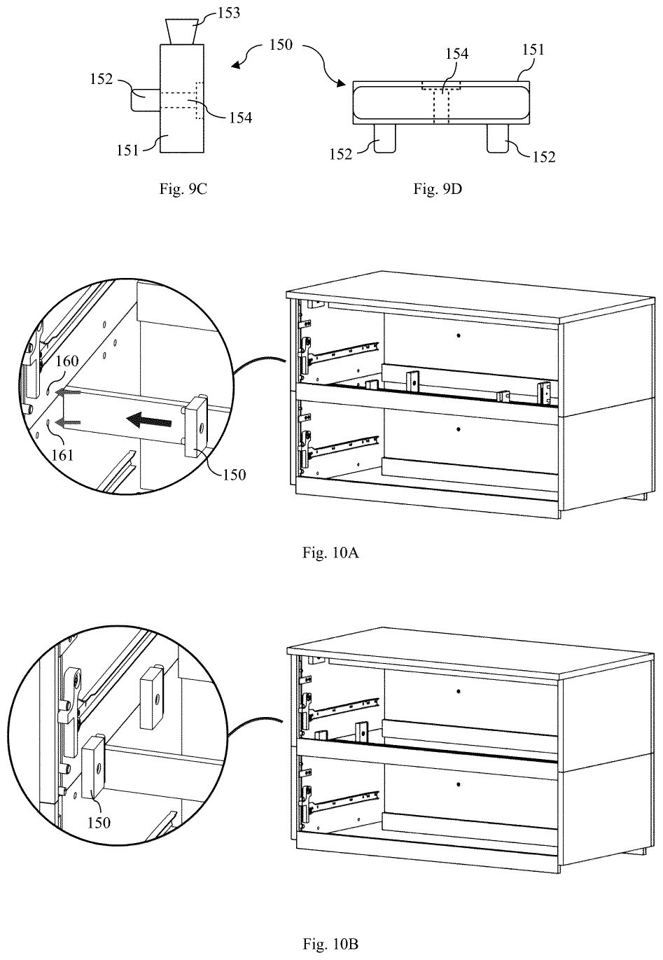

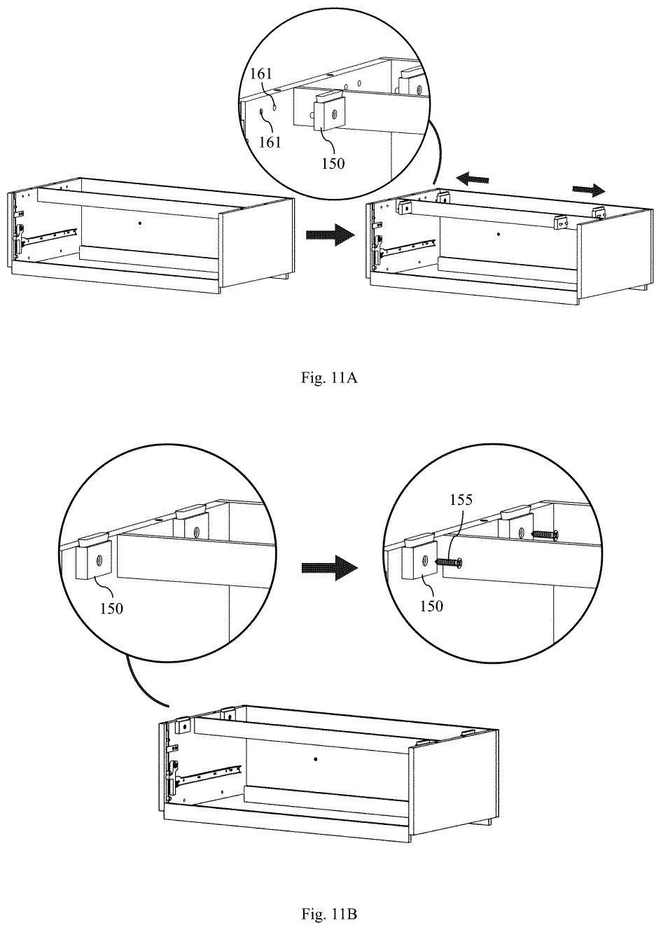

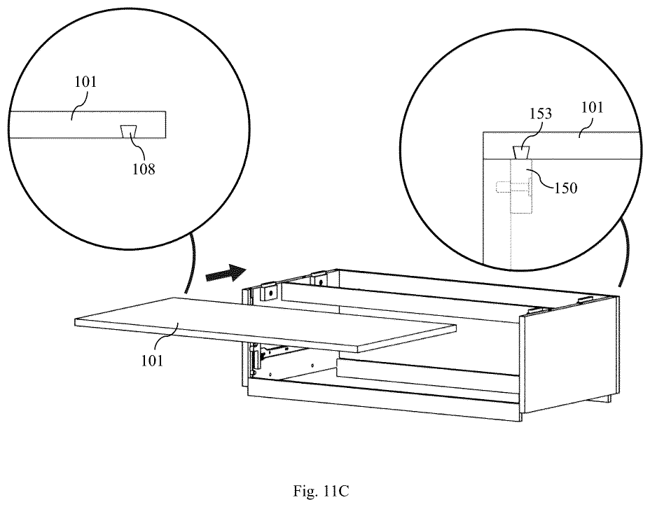

Referring to FIGS. 9A-9D, an example of the securing members 150 is illustrated. Preferably, each securing member 150 comprises a body 151 having a plurality of pins 152 for insertion to corresponding pinholes 160, 161 on the inner side of the side panel 102, and a tongue profile 153 on one edge of the body 151. Alternatively, each securing member 150 can also be provided with a threaded through hole 154 for screw attachment to the side panel 102. The functions of the securing members 150 are interchangeable depending on its orientation when attachment to the side panel 102. As shown in FIGS. 10A & 10B, when the securing member 150 is affixed to the inner side of the side panel 102 at a location between the two adjacent segmental portions 100 in a first orientation, at least one of the pins 152 is inserted to the pinhole 160 of one segmental portion 100, while the other pin 152 is inserted to the pinhole 161 of the other segmental portion 100. This effectively secures the stacking connection between the two adjacent segmental portions 100. Referring to FIGS. 11A-11C, when the securing member 150 is affixed to the inner side of the side panel 102 of one segmental portion 100 in a second orientation via inserting the pins 152 into the pinholes 161 of that segmental portion 100, the tongue profile 153 is readily positioned for receiving a groove 108 of the top panel 101. This effectively connects the top panel 101 to the respective segmental portion 100 via a tongue and groove interlocking joint. Nevertheless, it should be noted that the tongue and groove interlocking joint can be conveniently replaced by other types of existing interlocking joints. Alternatively, the groove 108 and the tongue profile 153 can be of dovetail shape. The attachment of the securing member 150 in its second orientation can be further secured via a screw 155.

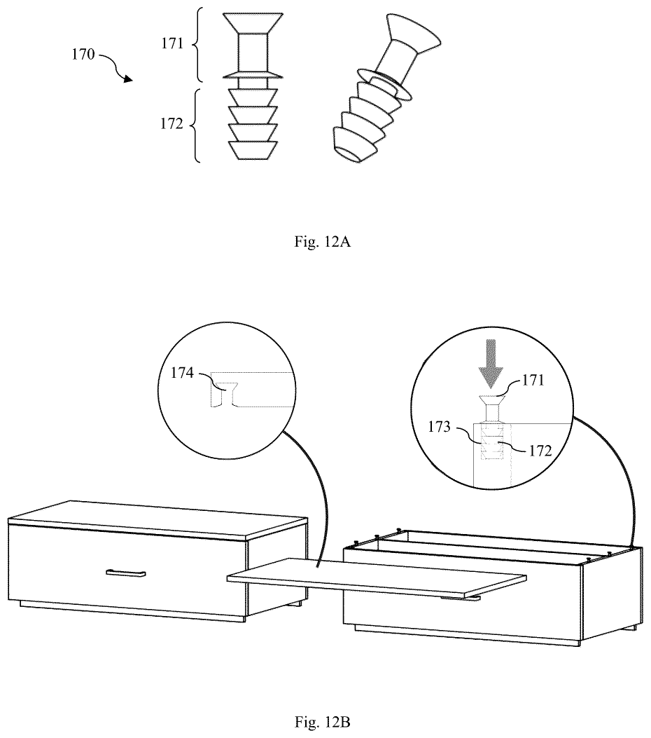

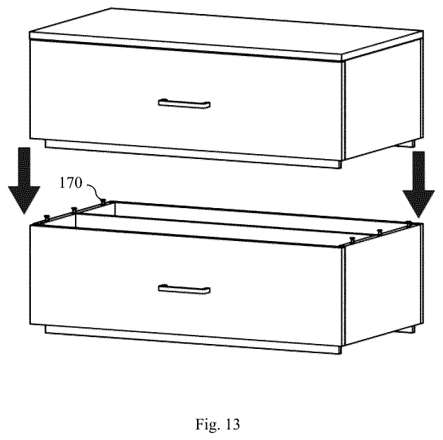

Referring to FIG. 12A, a further example of the securing members 170 is illustrated. Preferably, each securing member 170 comprises a first portion 171 and a second portion 172. The first portion 171 includes an enlarged end portion and the second portion includes a plurality of serrated teeth. As shown in FIG. 12B, the second portion 172 of each securing member 170 is inserted into a prefabricated hole on the side panels of a first segmental portion 100, leaving the first portion 171 exposed. The top panel 101 is provided with grooves 174 that conform to the shape of the first portion 171 so that the first portion 171 can be slidably inserted into the groove 174 and thereby facilitating the attachment of the top panel 101 to the segmental portion 100. During the stacking of a second segmental portion 100 to the first segmental portion 100 as shown in FIG. 13, the first portion 171 of the securing members 170 can be inserted into prefabricated holes on the second segmental portion 100 in order to align the stacking.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A furniture assembly comprising:
a plurality of segmental portions configured to be stackable one on top of another to form a complete furniture body;
wherein each segmental portion includes at least one drawer, at least one interlocking mechanism, and at least one securing member for stabilizing the segmental portions and prevent unintended disassembly;
wherein the interlocking mechanism includes a locking bar slidably disposed on a side panel of the segmental portion, having a plurality of spaced protrusions distributed along a length of the locking bar, and a rotatable block having a first portion pivotably connected to the side panel of the segmental portion, a second portion engageable by a sliding mechanism of a respective drawer, and a third portion that is engageable with one of the protrusions;
wherein the locking bars of two adjacent segmental portions are connected by a detachable connector such that all the locking bars of the stacked segmental portions are interconnected with synchronized movements, and the interconnected locking bars are movable between a locked position and an unlocked position; and
wherein when the at least one drawer is moving towards an open position, at least one sliding mechanism of that particular drawer engages the second portion of the corresponding rotatable block, causing the third portion of that corresponding rotatable block moves to engage with the respective protrusion, thereby moving the interconnected locking bars to the locked position, causing the remaining protrusions on the interconnected locking bars to move in a synchronized manner to a position that intercept a rotation pathway of the remaining rotatable blocks, preventing the remaining drawers from movement.

2. The furniture assembly according to claim 1, wherein the rotatable blocks are a T-shaped blocks.

3. The furniture assembly according to claim 1, wherein the connector includes a plurality of holes for receiving the further protrusions on the locking bars, each hole includes a larger protrusion receiving portion to easily accommodate the further protrusion and a narrowed protrusion receiving portion to allow the received further protrusion to slide thereinto for firm gripping of the further protrusion.

4. The furniture assembly according to claim 1, wherein at least one end of each locking bar includes at least one dovetail tongue profile that is insertable to a dovetail tongue receiving portion of the connector to form a dovetail joint.

5. The furniture assembly according to claim 1, wherein at least one end of each locking bar includes a protrusion that is insertable into a recess on the connector and an opening dimension of the recess is slightly narrower than the diameter of the protrusion in such a way that it can be inserted into the recess in a snap-on manner.

6. The furniture assembly according to claim 1, wherein at least one end of each locking bar includes an enlarged head portion that is insertable into a recess on the connector and is secured by a pair of snap-fit members, forming a cantilever snap-fit joint.

7. The furniture assembly according to claim 1, wherein the securing member comprises a body having a plurality of pins for insertion to corresponding pinholes on an inner side of the side panel, and a tongue profile on one edge of the body.

8. The furniture assembly according to claim 7, wherein the securing member is attached to the inner side of the side panel at a position between two adjacent segmental portions in a first orientation where at least one of the pins is inserted to the pinhole of one segmental portion and the other pin is inserted to the pinhole of the other segmental portion, thereby securing the stacking connection between the adjacent segmental portions.

9. The furniture assembly according to claim 7, wherein the securing member is attached to the inner side of the side panel of a respective segmental portion in a second orientation where the tongue profile is readily positioned to slidably receive a groove of a further panel, thereby connecting the further panel to the respective segmental portion via a tongue and groove interlocking joint.

10. The furniture assembly according to claim 1, wherein the securing member includes a second portion with a plurality of serrated teeth for insertion into prefabricated holes on a first segmental portions, and a first portion with an enlarged end portion for either the attachment of a further panel or the insertion into a prefabricated hole on a second segmental portion to align the first and second segmental portions during stacking.

11. The furniture assembly according to claim 1, wherein the stacked segmental portions are further secured by an attachment of at least one further panel.

12. The furniture assembly according to claim 1, wherein the segmental portions are stacked and joined via dowel pins.

13. The furniture assembly according to claim 1, wherein each segmental portion includes a flange portion that extends towards an adjacent segmental portion, the flange portion serves as a guide to facilitate the stacking of the segmental portions.
